(19) United States
(12) Patent Application Publication
(10) Pub. No.: US 2011/0303883 A1
(43) Pub. Date: Dec. 15, 2011

(54) GLASS COMPOSITION FOR ELECTRODE FORMATION AND ELECTRODE FORMATION MATERIAL

(76) Inventor: Kentaro Ishihara, Shiga (JP)

(21) Appl. No.: 13/202,626

(22) PCT Filed: Feb. 23, 2010
(86) PCT No.: PCT/JP2010/052672

§ 371 Date: Aug. 22, 2011

(30) Foreign Application Priority Data
Feb. 24, 2009 (JP) 2009-040107

(51) Int. Cl. H01B 1/16; C03C 3/066; C03C 3/064; C03C 3/14

(52) U.S. Cl. 252/512; 501/49; 501/79; 501/77; 252/514

(57) ABSTRACT

A glass composition for electrode formation includes, as a glass composition expressed in terms of oxides by mass %, 60 to 90% of Bi₂O₃, 2 to 25% of B₂O₃, 0 to 25% of ZnO, 0.01 to 20% of MgO+CaO+SrO+BaO, and 0 to 25% of SiO₂.

### TECHNICAL FIELD

The present invention relates to a glass composition for electrode formation and an electrode formation material, and more particularly, to a glass composition for electrode formation and an electrode formation material suitable for forming a back-surface electrode of a silicon solar cell (including a monocrystalline silicon solar cell, a polycrystalline silicon solar cell, a microcrystalline silicon solar cell, and an amorphous silicon solar cell).

### BACKGROUND ART

A silicon solar cell is provided with a silicon semiconductor substrate, a light-receiving surface electrode, a back-surface electrode, an anti-reflective film, and the like. A grid-like light-receiving surface electrode is formed on the light-receiving surface side of the silicon semiconductor substrate, and the back-surface electrode is formed on the back surface side of the silicon semiconductor substrate. Further, an Ag electrode or the like is generally used as the light-receiving surface electrode, and an Al electrode or the like is generally used as the back-surface electrode.

The back-surface electrode is usually formed by a thick-film processing. The thick-film processing is a method of forming a back-surface electrode on a silicon semiconductor substrate, involving screen printing an electrode formation material on a silicon semiconductor substrate so that a desired electrode pattern is formed, and firing the electrode formation material and the silicon semiconductor substrate at a maximum temperature of 660 to 900° C. for a short time (specifically, for 2 to 3 minutes from the start of the firing to the finish and the maximum temperature is kept for 10 to 30 seconds), to thereby disperse Al on the silicon semiconductor substrate.

The electrode formation material to be used for forming the back-surface electrode includes an Al powder, a glass powder, and a vehicle. When the electrode formation material is fired, the Al powder reacts with Si in the silicon semiconductor substrate, thereby forming an Al—Si alloy layer at the interface between the back-surface electrode and the silicon semiconductor substrate, and at the same time, forming a p+ electrolytic layer (back surface field layer, or also referred to as a BSF layer) at the interface between the Al—Si alloy layer and the silicon semiconductor substrate. The formation of the p+ electrolytic layer prevents the rebinding of electrons, thereby being able to provide an effect of improving efficiency in collecting carriers produced, that is, the so-called BSF effect. The formation of the p+ electrolytic layer can result in an increase in the photoelectric conversion efficiency of a silicon solar cell.

### CITATION LIST

### Patent Document

[Patent Document 1] JP 2000-90733 A
[Patent Document 2] JP 2003-165744 A

### SUMMARY OF INVENTION

### Technical Problem

A glass powder included in an electrode formation material has an action of imparting a BSF effect by promoting a reaction between an Al powder and Si to form a p+ electrolytic layer at the interface between an Al—Si alloy layer and a silicon semiconductor substrate (see Patent Document 1 and 2).

However, when a conventional glass powder, specifically, a lead borate-based glass powder is used, the reaction between an Al powder and Si becomes non-uniform, resulting in a local increase in the generation amount of an Al—Si alloy. Then, a blister or aggregation of Al occurs. As a result, the photoelectric conversion efficiency of the silicon solar cell lowers, and a crack or the like becomes liable to occur in the silicon semiconductor substrate in the production process of the silicon solar cell, and hence the production efficiency of the silicon solar cell lowers.

Further, in order to reduce the production cost of a silicon solar cell, studies have been made in recent years on how to reduce the thickness of a silicon semiconductor substrate. When the thickness of the silicon semiconductor substrate is reduced, due to a difference in thermal expansion coefficient between Al and the silicon semiconductor substrate, such warpage that causes a back surface side on which a back-surface electrode is formed to have a concave shape becomes liable to occur in the silicon semiconductor substrate, after an electrode formation material is fired. When the coating amount of the electrode formation material is deceased and the thickness of the back-surface electrode is reduced, the warpage of the silicon semiconductor substrate can be suppressed. However, when the coating amount of the electrode formation material is reduced, a blister or aggregation of Al easily occurs during the firing of the electrode formation material.

In view of the above-mentioned circumstances, a technical object of the present invention is to create a glass composition for electrode formation and an electrode formation material which resist the occurrence of a blister or aggregation of Al and are suitable for forming the Al—Si alloy layer and the p+ electrolytic layer, thereby reducing the production cost of the silicon solar cell while enhancing the characteristics of the silicon solar cell, such as photoelectric conversion efficiency.

### Solution to Problem

The inventor of the present invention has made intensive efforts. As a result, the inventor has found that the above-mentioned technical problems can be solved by using Bi₂O₃—B₂O₃—ZnO-based glass and introducing a predetermined amount of alkaline-earth metal oxides in a glass composition. Thus, the finding is proposed as the present invention. That is, a glass composition for electrode formation according to the present invention includes, as a glass composition expressed in terms of oxides by mass %, 60 to 90% of Bi₂O₃, 2 to 25% of B₂O₃, 0 to 25% of ZnO, 0.01 to 20% of MgO+CaO+SrO+BaO (total content of MgO, CaO, SrO, and BaO), and 0 to 25% of SiO₂.

When Bi₂O₃ and B₂O₃ are introduced as main components of glass, the reaction between an Al powder and Si can be easily uniformed while the reaction between an Al powder and Si is promoted, and hence a blister or aggregation of Al can be suppressed. Further, when Bi₂O₃—B₂O₃-based glass is used, a p+ electrolytic layer becomes liable to be formed as compared with a case where lead borate-based glass is used. As a result, the BSF effect becomes liable to be provided and the photoelectric conversion efficiency of a silicon solar cell can be enhanced.

Further, when MgO+CaO+SrO+BaO is introduced in a content equal to or more than the predetermined value, a blister or aggregation of Al can be suppressed. When the content of MgO+CaO+SrO+BaO is controlled in a value equal to or less than the predetermined value, it becomes easy to prevent a situation that the BSF effect becomes unlikely to be provided. When the content of ZnO is controlled in a value equal to or less than the predetermined value, a blister or aggregation of Al can be suppressed. When the content of SiO₂ is controlled in a value equal to or less than the predetermined value, it becomes easy to prevent a situation that the softening point of glass unreasonably increases, or a situation that the thermal stability of glass lowers and the glass devitrifies during the firing of an electrode formation material. Thus, when the content of each of Bi₂O₃, B₂O₃, ZnO, MgO+CaO+SrO+BaO, and SiO₂ is controlled in a predetermined range, the production cost of a silicon solar cell can be reduced while characteristics of the silicon solar cell, such as photoelectric conversion efficiency, are enhanced.

In the glass composition for electrode formation of the present invention, the content of ZnO is preferably 7.9% or less. When the content of ZnO is controlled to 7.9% or less, a blister or aggregation of Al becomes liable to be suppressed.

In the glass composition for electrode formation of the present invention, the content of ZnO is preferably smaller than that of B₂O₃. Thus, a blister or aggregation of Al becomes liable to be suppressed.

In the glass composition for electrode formation of the present invention, the content of CaO is preferably 0.1 to 20%. When CaO is introduced in a content equal to or more than the predetermined value, a blister or aggregation of Al can be suppressed remarkably. When the content of CaO is controlled in a value equal to or less than the predetermined value, it becomes easy to prevent the situation that the BSF effect becomes unlikely to be provided.

In the glass composition for electrode formation of the present invention, the content of BaO is preferably 0.1 to 20%. When BaO is introduced in a content equal to or more than the predetermined value, the thermal stability of glass improves remarkably and the glass becomes unlikely to denitrify during the firing of an electrode formation material. On the other hand, when the content of BaO is controlled in a value equal to or less than the predetermined value, it becomes easy to prevent the situation that the BSF effect becomes unlikely to be provided.

In the glass composition for electrode formation of the present invention, the content of SiO₂ is preferably less than 3%. Thus, it becomes easy to prevent the situation that the softening point of glass unreasonably increases, or the situation that the thermal stability of glass lowers and the glass devitrifies during the firing of an electrode formation material.

In electrode formation material of the present invention preferably includes a glass powder including the above-mentioned glass composition for electrode formation, a metal powder, and a vehicle. Thus, an electrode pattern can be formed by a thick-film processing and the production efficiency of the silicon solar cell can be enhanced. Here, the term “vehicle” generally refers to a substance obtained by dissolving a resin in an organic solvent. However, in the present invention, the term “vehicle” includes, as one aspect, a substance that does not contain a resin and is formed of only a highly viscous organic solvent (for example, a higher alcohol such as isotridecyl alcohol).

In the electrode formation material of the present invention, the glass powder preferably has an average particle diameter D₅₀ of less than 5 μm. Here, the phrase “average particle diameter D₅₀” refers to a value measured by laser diffractometry and represents, in a cumulative particle size distribution curve in terms of volume prepared based on the measurements by laser diffractometry, a particle diameter at which the cumulative amount of particles starting from a particle having the smallest diameter reaches 50%.

In the electrode formation material of the present invention, the glass powder preferably has a softening point of 500° C. or less. Thus, the back-surface electrode can be formed at low temperatures. Here, the phrase “softening point” refers to a value obtained by measurement with a macro-type differential thermal analysis (DTA) apparatus, and in the DTA, the measurement starts from room temperature and the temperature rise rate is set to 10° C./min. Note that the softening point measured with the macro-type DTA apparatus refers to the temperature (Ts) at the fourth bending point illustrated in FIG. 1.

In the electrode formation material of the present invention, the glass powder preferably has a crystallization temperature of 600° C. or more. Thus, the thermal stability of glass is improved and the glass becomes unlikely to denitrify during the firing of the electrode formation material. As a result, the mechanical strength of a back-surface electrode becomes unlikely to lower. Here, the phrase “crystallization temperature” refers to a peak temperature measured with a macro-type DTA apparatus, and in the DTA, the measurement starts from room temperature and the temperature rise rate is set to 10° C./min.

In the electrode formation material of the present invention, the content of the glass powder is preferably 0.2 to 10 mass %. Thus, the p+ electrolytic layer is formed at the interface between an Al—Si alloy layer and a silicon semiconductor substrate and the BSF effect becomes liable to be provided.

In the electrode formation material of the present invention, the metal powder preferably includes one kind of powder or two or more kinds of powders of Ag, Al, Au, Cu, Pd, Pt, and alloys thereof. Any of these metal powders has good compatibility with the glass powder according to the present invention and has the property that is hard to generate bubbles in the glass during the firing of the electrode formation material.

In the electrode formation material of the present invention, the metal powder preferably includes an Al powder.

The electrode formation material of the present invention is preferably used for the electrode of the silicon solar cell.

The electrode formation material of the present invention is preferably used for the back-surface electrode of the silicon solar cell.

### BRIEF DESCRIPTION OF DRAWINGS

FIG. 1 is a schematic view showing a softening point of a glass powder obtained by measurement with a macro-type DTA apparatus.

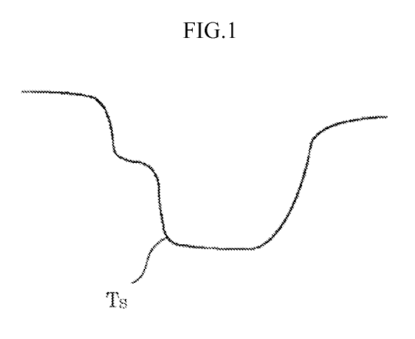

### DESCRIPTION OF EMBODIMENTS

The reasons why the content ranges of respective components were defined to those described above in a glass composition for electrode formation of the present invention are described below. Note that unless otherwise specified, “%” described below refers to mass %.

Bi₂O₃ is a component that forms the framework of glass, providing the effect of suppressing a blister or aggregation of Al and lowering the softening point of glass, when contained as a main component. The content of Bi₂O₃ is 60 to 90%, preferably 67 to 86%, more preferably 69 to 86%, still more preferably 75 to 82.5%. When the content of Bi₂O₃ is smaller, the reaction between an Al powder and Si becomes liable to be nonuniform, resulting in a local increase in the generation amount of an Al—Si alloy, and a blister or aggregation of Al liable to occur. Further, when the content of Bi₂O₃ is smaller, the softening point of glass becomes too high, and hence forming a back-surface electrode at low temperatures becomes difficult. On the other hand, when the content of Bi₂O₃ is larger, the thermal stability of glass lowers. As a result, during the firing of the electrode formation material, glass becomes liable to devitrify and the mechanical strength of a back-surface electrode becomes liable to lower.

B₂O₃ is a component that forms the framework of glass, providing an effect of suppressing a blister or aggregation of Al, when contained as a main component. Further, B₂O₃ is a component that enhances the thermal stability of glass and lowers the softening point of glass. The content of B₂O₃ is 2 to 25%, preferably 3 to 14.5%, more preferably 4 to 13%, particularly preferably 6 to 10.5%. When the content of B₂O₃ is smaller, the reaction between an Al powder and Si becomes liable to be nonuniform, resulting in the local increase in the generation amount of the Al—Si alloy, and the blister or aggregation of Al becomes liable to occur. Further, when the content of B₂O₃ is smaller, the thermal stability of glass lowers. As a result, during the firing of the electrode formation material, glass becomes liable to devitrify and the mechanical strength of a back-surface electrode becomes liable to lower. On the other hand, when the content of B₂O₃ is larger, the water resistance of glass becomes liable to lower. As a result, the long-term reliability of the back-surface electrode lowers, and further, the phase separation of glass becomes liable to occur so that the Al—Si alloy layer and a p+ electrolytic layer becomes hard to be uniformly formed.

ZnO is a component that improves the thermal stability of glass and lowers the softening point of the glass without rising the thermal expansion coefficient of the glass. The content of ZnO is 0 to 25%, preferably 1 to 16%, more preferably 1.5 to 12%, still more preferably 2 to 7.9%, particularly preferably 3 to 7%. When the content of ZnO is smaller, the thermal stability of glass lowers. As a result, during the firing of the electrode formation material, glass becomes liable to denitrify and the mechanical strength of a back-surface electrode becomes liable to lower. On the other hand, when the content of ZnO is larger, the reaction between an Al powder and Si becomes liable to be nonuniform, resulting in a local increase in the generation amount of an Al—Si alloy, and a blister or aggregation of Al is liable to occur. Further, when the content of ZnO is larger, the balance of components in a glass composition is lost, with the result that crystals are liable to precipitate in glass. In addition, the content of ZnO is preferably smaller than that of B₂O₃. When the content of ZnO is decreased with respect to the content of B₂O₃, a blister or aggregation of Al tends to be unlikely to occur.

MgO+CaO+SrO+BaO are components that suppress the blister or aggregation of Al. The content of MgO+CaO+SrO+BaO is 0.01 to 20%, 0.1 to 20%, 1 to 15%, particularly preferably 3 to 10%. When the content of MgO+CaO+SrO+BaO is smaller, the reaction between an Al powder and Si becomes liable to be nonuniform, resulting in the local increase in the generation amount of the Al—Si alloy, and the blister or aggregation of Al becomes liable to occur. On the other hand, when the content of MgO+CaO+SrO+BaO is larger, it becomes difficult to form the p+ electrolytic layer. As a result, providing the BSF effect becomes difficult and the photoelectric conversion efficiency of the silicon solar cell becomes liable to lower. Further, when the content of MgO+CaO+SrO+BaO is larger, the balance of components in a glass composition is lost so that crystals are liable to precipitate in glass.

MgO is a component that suppresses the blister or aggregation of Al. The content of MgO is 0 to 5%, 0.1 to 3%, particularly preferably 0 to 1%. When the content of MgO is larger, it becomes difficult to form the p+ electrolytic layer. As a result, providing the BSF effect becomes difficult and the photoelectric conversion efficiency of the silicon solar cell becomes liable to lower.

CaO is a component that has a high effect of suppressing the blister or aggregation of Al. The content of CaO is 0 to 20%, 0.01 to 10%, 0.1 to 8%, 0.5 to 5%, particularly preferably 1 to 4%. When the content of CaO is smaller, the reaction between an Al powder and Si becomes liable to be nonuniform, resulting in the local increase in the generation amount of the Al—Si alloy, and the blister or aggregation of Al becomes liable to occur. On the other hand, when the content of CaO is larger, it becomes difficult to form the p+ electrolytic layer. As a result, providing the BSF effect becomes difficult and the photoelectric conversion efficiency of the silicon solar cell becomes liable to lower.

SrO is a component that suppresses the blister or aggregation of Al and enhances the thermal stability of glass. The content of SrO is 0 to 15%, 0 to 10%, particularly preferably 0 to 5%. When the content of SrO is larger, it becomes difficult to form the p+ electrolytic layer. As a result, providing the BSF effect becomes difficult and the photoelectric conversion efficiency of the silicon solar cell becomes liable to lower. Further, when the content of SrO is larger, the balance of components in a glass composition is lost so that crystals are liable to precipitate in glass.

BaO is a component that suppresses the blister or aggregation of Al and remarkably enhances the thermal stability of glass. The content of BaO is 0 to 20%, 0.01 to 15%, 0.1 to 12%, 1 to 10%, particularly preferably 3 to 9%. When the content of BaO is smaller, the reaction between an Al powder and Si becomes liable to be nonuniform, resulting in the local increase in the generation amount of the Al—Si alloy, and the blister or aggregation of Al becomes liable to occur. On the other hand, when the content of BaO is larger, it becomes difficult to form the p+ electrolytic layer. As a result, providing the BSF effect becomes difficult and the photoelectric conversion efficiency of the silicon solar cell becomes liable to lower. Further, when the content of BaO is larger, the balance of components in a glass composition is lost so that crystals are liable to precipitate in glass.

SiO₂ is a component that enhances the water resistance of glass. However, as SiO₂ has an action of remarkably increasing the softening point of glass, the content of SiO₂ is 25% or less, preferably 8.5% or less, more preferably 5% or less, still more preferably 3% or less, particularly preferably less than 1%. When the content of SiO₂ is larger, the softening point of glass becomes too high, and hence forming the back-surface electrode at low temperatures becomes difficult.

The glass composition for electrode formation of the present invention may, for example, also contain the following components at up to 20%, preferably up to 10% in addition to the above-mentioned components.

CuO+Fe₂O₃ (total content of CuO and Fe₂O₃) are components that enhance the thermal stability of glass. The content of CuO+Fe₂O₃ is 0 to 15%, 0.1 to 10%, particularly preferably 1 to 10%. When the content of CuO+Fe₂O₃ is more than 15%, the balance of components in a glass composition is lost so that the thermal stability of glass tends to lower. In order to provide the BSF effect properly while suppressing a blister or aggregation of Al, it is necessary to add a large amount of Bi₂O₃ in a glass composition. However, when the content of Bi₂O₃ is increased, glass becomes liable to denitrify during the firing of an electrode formation material, and the mechanical strength of a back-surface electrode becomes liable to lower due to this devitrification. In particular, when the content of Bi₂O₃ becomes 75% or more, the tendency becomes remarkable. Thus, when CuO+Fe₂O₃ are added in a glass composition in an appropriate amount, the devitrification of glass can be suppressed even if the content of Bi₂O₃ is 75% or more. Note that the content of CuO is 0 to 15%, 0.1 to 10%, particularly preferably 1 to 5%. Further, the content of Fe₂O₃ is 0 to 10%, 0.05 to 5%, particularly preferably 0.2 to 3%. In addition, the content of CuO is preferably larger than that of BaO. As a result, a blister or aggregation of Al can be effectively suppressed.

Li₂O, Na₂O, K₂O, and Cs₂O are components that lower the softening point of glass. Those components have an effect of promoting the denitrification of glass during melting, and hence the content of each of those components is preferably 2% or less.

Sb₂O₃ is a component that enhances the thermal stability of glass. The content of Sb₂O₃ is 0 to 7%, particularly preferably 0.1 to 3%. When the content of Sb₂O₃ is too large, the balance of components in a glass composition is lost so that the thermal stability of glass becomes liable to lower. Note that the use of Sb₂O₃ is restricted in some cases from the viewpoint of environment. In that case, the glass composition is preferably substantially free of Sb₂O₃. Here, the phrase “substantially free of Sb₂O₃” refers to the case where the content of Sb₂O₃ in a glass composition is 1000 ppm or less.

Nd₂O₃ is a component that enhances the thermal stability of glass. The content of Nd₂O₃ is 0 to 10%, 0 to 5%, particularly preferably 0.1 to 3%. When Nd₂O₃ is added in a glass composition in a predetermined amount, the glass network of Bi₂O₃—B₂O₃-based glass is stabilized. As a result, crystals of Bi₂O₃ (bismite) or crystals of 2Bi₂O₃.B₂O₃, 12Bi₂O₃.B₂O₃, or the like formed of Bi₂O₃ and B₂O₃ become unlikely to precipitate during the firing. Note that when the content of Nd₂O₃ is too large, the balance of components in a glass composition is lost so that the crystals are liable to precipitate in glass.

WO₃ is a component that enhances the thermal stability of glass. The content of WO₃ is 0 to 5%, particularly preferably 0 to 2%. When the content of WO₃ is too large, the balance of components in a glass composition is lost so that the thermal stability of glass becomes liable to lower.

In₂O₃+Ga₂O₃ (total content of In₂O₃ and Ga₂O₃) are components that enhance the thermal stability of glass. The content of In₂O₃+Ga₂O₃ is 0 to 5%, 0 to 3%, particularly preferably 0 to 1%. When the content of In₂O₃+Ga₂O₃ is too large, the balance of components in a glass composition is lost so that the thermal stability of glass becomes liable to lower. Note that the content of each of In₂O₃ and Ga₂O₃ is preferably 0 to 2%.

P₂O₅ is a component that suppresses the denitrification of glass during melting. However, when the content of P₂O₅ is large, the phase separation of glass becomes liable to occur during melting, and hence it becomes difficult to form uniformly an Al—Si alloy layer and a p+ electrolytic layer. Thus, the content of P₂O₅ is preferably 1% or less.

MoO+La₂O₃+Y₂O₃+CeO₂ (total content of MoO₃, La₂O₃, Y₂O₃, and CeO₂) have an effect of suppressing the phase separation of glass during melting. However, when the content of these components is large, the softening point of glass becomes too high, and hence it becomes difficult to sinter the electrode formation material at low temperatures. Thus, the content of MoO₃+La₂O₃+Y₂O₃+CeO₂ is preferably 3% or less. Note that the content of each of MoO₃, La₂O₃, Y₂O₃, and CeO₂ is preferably 0 to 2%.

It is not eliminated that the bismuth-based glass composition of the present invention contains PbO, but the bismuth-based glass composition is preferably substantially free of PbO from the viewpoint of environment. Further, as PbO makes the blister or aggregation of Al liable to occur, the bismuth-based glass composition is preferably substantially free of PbO when the bismuth-based glass composition is used for the formation of the back-surface electrode of the silicon solar cell. Here, the phrase “substantially free of PbO” refers to the case where the content of PbO in a glass composition is 1000 ppm or less.

The electrode formation material of the present invention includes a glass powder which includes the above-mentioned glass composition for electrode formation, a metal powder, and a vehicle. The glass powder is a component that promotes a reaction between an Al powder and Si and forms a p+ electrolytic layer at the interface between an Al—Si alloy layer and a silicon semiconductor substrate, thereby imparting the BSF effect. The metal powder is a main component forming electrodes and for securing conductivity. The vehicle is a component for making the electrode formation material a paste state and for imparting viscosity suitable for printing.

In the electrode formation material of the present invention, the average particle diameter D₅₀ of the glass powders is preferably less than 5 μm, 4 μm or less, 3 μm or less, 2 μm or less, 1 μm or less, particularly preferably less than 1 μm. When the average particle diameter D₅₀ of the glass powders is 5 μm or more, the surface areas of the glass powders become small, so that promoting the reaction between an Al powder and Si becomes difficult and providing the BSF effect becomes difficult. Further, when the average particle diameter D₅₀ of the glass powders is 5 μm or more, the softening point of the glass powders rises and the temperature region for forming the electrodes rises. Further, when the average particle diameter D₅₀ of the glass powders is 5 μm or more, forming a fine electrode pattern becomes difficult, and hence the photoelectric conversion efficiency of a silicon solar cell becomes liable to lower. On the other hand, although the lower limit of the average particle diameter D₅₀ of the glass powders is not particularly limited, when the average particle diameter D₅₀ of the glass powders is too small, the handling ability and the material yield of the glass powders are liable to lower. When the circumstances described above are taken into consideration, the average particle diameter D₅₀ of the glass powders is preferably 0.1 μm or more. Note that glass powders having the above-mentioned average particle diameter D₅₀ can be produced by the following method: (1) a glass film is pulverized in a ball mill and the resultant glass powder is then subjected to air classification; or (2) a glass film is roughly pulverized in a ball mill or the like and the resultant glass is then subjected to wet pulverization in a bead mill or the like.

In the electrode formation material of the present invention, the maximum particle diameter Dₘₐₓ of the glass powders is preferably 25 μm or less, 20 μm or less, 15 μm or less, 10 μm or less, particularly preferably less than 10 μm. When the maximum particle diameter Dₘₐₓ of the glass powders is more than 25 μm, forming a fine electrode pattern becomes difficult, and hence the photoelectric conversion efficiency of the silicon solar cell becomes liable to lower. Here, the phrase “average particle diameter Dₘₐₓ” refers to a value measured by laser diffractometry and represents, in a cumulative particle size distribution curve in terms of volume prepared based on the measurements by laser diffractometry, a particle diameter at which the cumulative amount of particles starting from a particle having the smallest diameter reaches 99%.

In the electrode formation material of the present invention, the density of the glass powder is preferably 7.0 g/cm³ or less, 6.5 g/cm³ or less, particularly preferably 6.2 g/cm³ or less. According to survey of the inventor of the present invention, as the volume of the glass powder is larger, the reactivity between an Al powder and Si improves. Thus, as the density of the glass powder is smaller, the reactivity between an Al powder and Si improves in terms of the unit weight of the glass powder, and hence the BSF effect becomes liable to be provided.

In the electrode formation material of the present invention, the softening point of the glass powder is preferably 500° C. or less, particularly preferably 480° C. or less. When the softening point of the glass powder is more than 500° C., the temperature region for forming the electrodes rises, and hence the production efficiency of the silicon solar cell lowers. Note that when the softening point of the glass powder is too low, it becomes difficult to control the reaction between the Al powder and Si, and as a result, it becomes difficult to conduct stable production. Thus, the softening point of the glass powder is preferably 400° C. or more.

In the electrode formation material of the present invention, the crystallization temperature of the glass powder is preferably 600° C. or more, 620° C. or more, particularly preferably 650° C. or more. When the crystallization temperature of the glass powder is less than 600° C., the thermal stability of glass lowers. As a result, during the firing of the electrode formation material, the glass becomes liable to denitrify and the mechanical strength of a back-surface electrode becomes liable to lower. Further, when the glass devitrifies completely, promoting the reaction between an Al powder and Si becomes difficult and providing the BSF effect becomes difficult.

In the electrode formation material of the present invention, the content of the glass powder is preferably 0.2 to 10 mass %, 0.5 to 6 mass %, 0.7 to 4 mass %, particularly preferably 1 to 3 mass %. When the content of the glass powder is less than 0.2 mass %, the reaction between an Al powder and Si becomes nonuniform, resulting in a local increase in the generation amount of an Al—Si alloy, a blister or aggregation of Al becomes liable to occur, and further, the mechanical strength of a back-surface electrode becomes liable to lower. On the other hand, when the content of the glass powder is more than 10 mass %, segregation of glass becomes liable to occur after the firing of the electrode formation material and the conductivity of the back-surface electrode lowers. As a result, the photoelectric conversion efficiency of a silicon solar cell may lower. Further, because of the same reasons as those described above, the mass ratio of the content of the glass powder to the content of the metal powder is preferably 0.3:99.7 to 13:87, 1.5:98.5 to 7:93, particularly preferably 1.8:98.2 to 4:96.

In the electrode formation material of the present invention, because of the same reasons as those described above, the volume ratio of the content of the glass powder to the content of the metal powder is preferably 1:99 to 10:90, 2:98 to 6:94, particularly preferably 2.5:97.5 to 5:95. When the content of the glass powder is smaller, the reaction between an Al powder and Si becomes nonuniform, resulting in a local increase in the generation amount of an Al—Si alloy, a blister or aggregation of Al becomes liable to occur, and further, the mechanical strength of a back-surface electrode becomes liable to lower. On the other hand, when the content of the glass powder is larger, segregation of glass becomes liable to occur after the firing of the electrode formation material and the conductivity of the back-surface electrode lowers. As a result, the photoelectric conversion efficiency of a silicon solar cell may lower.

In the electrode formation material of the present invention, the content of the metal powder is preferably 50 to 97 mass %, 65 to 95 mass %, particularly preferably 70 to 92 mass %. When the content of the metal powder is less than 50 mass-%, the conductivity of the back-surface electrode lowers. As a result, the photoelectric conversion efficiency of the silicon solar cell becomes liable to lower. On the other hand, when the content of the metal powder is more than 97 mass %, the content of the glass powder or the vehicle must be reduced, and hence it becomes difficult to form a p+ electrolytic layer.

In the electrode formation material of the present invention, the metal powder preferably includes one kind of powder or two or more kinds of powders of Ag, Al, Au, Cu, Pd, Pt, and alloys thereof, particularly preferably includes the Al powder in terms of providing the BSF effect. These metal powders have good conductivity and good compatibility with the glass powder according to the present invention. Thus, when any of those metal powders is used, glass becomes unlikely to denitrify during the firing of the electrode formation material, and also unlikely to generate bubbles. Further, in order to form a fine electrode pattern, the average particle diameter D₅₀ of the metal powders is preferably 5 μm or less, 3 μm or less, 2 μm or less, particularly preferably 1 μm or less.

In the electrode formation material of the present invention, the content of the vehicle is preferably 5 to 50 mass %, particularly preferably 10 to 30 mass %. When the content of the vehicle is less than 5 mass %, making the electrode formation material a paste state becomes difficult, and hence it becomes difficult to form the electrodes by a thick-film processing. On the other hand, when the content of the vehicle is more than 50 mass %, film thickness and film width are liable to vary before and after the firing of the electrode formation material. As a result, it becomes difficult to form a desired electrode pattern.

As described above, the term “vehicle” generally refers to a substance obtained by dissolving a resin in an organic solvent. Examples of the resin which may be used include an acrylic acid ester (acrylic resin), ethylcellulose, a polyethylene glycol derivative, nitrocellulose, polymethylstyrene, polyethylene carbonate, and a methacrylic acid ester. In particular, an acrylic acid ester, nitrocellulose, and ethylcellulose are preferred because of good thermolytic property. Examples of the organic solvent which may be used include N,N′-dimethylformamide (DMF), α-terpineol, a higher alcohol, γ-butyrolactone (γ-BL), tetralin, butyl carbitol acetate, ethyl acetate, isoamyl acetate, diethylene glycol monoethyl ether, diethylene glycol monoethyl ether acetate, benzyl alcohol, toluene, 3-methoxy-3-methylbutanol, water, triethylene glycol monomethyl ether, triethylene glycol dimethyl ether, dipropylene glycol monomethyl ether, dipropylene glycol monobutyl ether, tripropylene glycol monomethyl ether, tripropylene glycol monobutyl ether, propylene carbonate, dimethyl sulfoxide (DMSO), and N-methyl-2-pyrrolidone. In particular, α-terpineol is preferred because of high viscosity and good solubility for a resin and the like.

The electrode formation material of the present invention may contain, in addition to the above-mentioned components, a ceramic filler powder such as cordierite for adjusting the thermal expansion coefficient, an oxide powder such as NiO for adjusting the surfaces resistance of the electrodes, a surfactant, a thickener, a plasticizer, or a surface treating agent for adjusting the paste characteristic, a pigment for adjusting the color tone, and the like.

The electrode formation material (glass composition for electrode composition) of the present invention is suitable for forming not only the back-surface electrode but also the light-receiving surface electrode. When the light-receiving surface electrode is formed by a thick-film processing, the phenomenon that the electrode formation material penetrates the anti-reflective film during the firing is taken advantage of to electrically connect the light-receiving surface electrode with a semiconductor layer. The phenomenon is generally called fire through. Taking advantage of the fire through, when forming the light-receiving surface electrode, it becomes unnecessary to etch the anti-reflective film, and further, it becomes unnecessary to position an etching on the anti-reflective film with an electrode pattern. As a result, the production efficiency of the silicon solar cell improves dramatically. The degree of how much the electrode formation material penetrates the anti-reflective film (hereinafter, referred to as fire through property) varies depending on the composition of the electrode formation material and a firing condition, and in particular, is influenced most significantly by the glass composition of the glass powder. In addition, the photoelectric conversion efficiency of the silicon solar cell has a correlation with the fire through property of the electrode formation material. When the fire through property is poor, the characteristics lower. As a result, the fundamental performance of the silicon solar cell lowers. In the electrode formation material of the present invention, the glass composition range of the glass powder is controlled in the predetermined range, and hence the electrode formation material has good fire through property and is suitable for forming the light-receiving surface electrode. When the electrode formation material of the present invention is used for forming the light-receiving surface electrode, an Ag powder is preferably used as the metal powder. The content or the like of the Ag powder is as described above.

The light-receiving surface electrode and the back-surface electrode may be formed separately, or the light-receiving surface electrode and the back-surface electrode may be formed simultaneously. When the light-receiving surface electrode and the back-surface electrode are formed simultaneously, the number of firing can be reduced, and hence the production efficiency of the silicon solar cell is improved. Here, when the electrode formation material of the present invention is used for both the light-receiving surface electrode and the back-surface electrode, it becomes easy to form the light-receiving surface electrode and the back-surface electrode simultaneously.

### EXAMPLES

### Example 1

Hereinafter, the present invention is described in detail based on examples.

Tables 1 to 4 show examples (Sample Nos. 1 to 20) and comparative examples (Sample Nos. 21 and 22) of the present invention. Sample Nos. 21 and 22 exemplify conventional glass compositions for electrode formation.

TABLE 1

| | | Example | | | | | | | |
|---|---|---|---|---|---|---|---|---|---|
| | | No. 1 | No. 2 | No. 3 | No. 4 | No. 5 | No. 6 | No. 7 | No. 8 |
| Glass | Bi₂O₃ | 71 | 83.3 | 68 | 82.3 | 82 | 70 | 82.5 | 86 |
| composition | B₂O₃ | 9.1 | 8 | 15 | 6 | 5 | 13 | 8 | 7 |
| (mass %) | ZnO | 8.9 | 8 | 6 | 10 | 5 | 6 | 4.7 | 1 |
| | MgO | — | — | — | — | — | — | — | 1 |
| | CaO | 8 | — | 1 | — | 1 | — | — | 0.5 |
| | SrO | 1 | — | — | — | — | — | — | — |
| | BaO | — | 0.6 | 7.5 | 0.2 | 5 | 9 | 2 | 0.5 |
| | SiO₂ | — | — | — | — | — | 0.9 | — | — |
| | CuO | — | 0.1 | 2 | 0.6 | 1 | 0.5 | 2 | 2 |
| | Fe₂O₃ | 0.5 | — | 0.5 | 0.1 | 0.5 | 0.5 | 0.5 | 0.5 |
| | Sb₂O₃ | 0.5 | — | — | 0.4 | — | — | 0.3 | 0.5 |
| | CeO₂ | — | — | — | — | 0.5 | 0.1 | — | — |
| | Al₂O₃ | 1 | — | — | 0.4 | — | — | — | 1 |

| | | | | | | | | |
|---|---|---|---|---|---|---|---|---|
| α(×10⁻⁷/° C.) | 98 | 111 | 95 | 113 | 115 | 97 | 111 | 116 |
| Softening point (° C.) | 444 | 413 | 450 | 398 | 392 | 447 | 412 | 391 |
| Thermal stability | ∘ | ∘ | ∘ | ∘ | ∘ | ∘ | ∘ | ∘ |
| Surface resistance of | Δ | ∘ | ∘ | ∘ | ∘ | ∘ | ∘ | ∘ |
| p+ electrolytic layer | | | | | | | | |
| Outer appearance | ∘ or Δ | Δ | ∘ | Δ | ∘ | ∘ | ∘ | ∘ |
| Warpage | ∘ | ∘ | ∘ | ∘ | ∘ | ∘ | ∘ | ∘ |

TABLE 2

| | | Example | | | | | |
|---|---|---|---|---|---|---|---|
| | | No. 9 | No. 10 | No. 11 | No. 12 | No. 13 | No. 14 |
| Glass | Bi₂O₃ | 76.4 | 76.4 | 76.7 | 76.4 | 79 | 76.4 |
| composition | B₂O₃ | 8.1 | 9.5 | 8.3 | 14.5 | 13.5 | 8.1 |
| (mass %) | ZnO | 6.4 | 3.8 | 6.5 | — | 0.5 | 6.4 |
| | CaO | — | — | 0.5 | 0.3 | — | 5.8 |
| | BaO | 5.8 | 6.5 | 4.6 | 5.5 | 1.5 | — |
| | CuO | 2.2 | 2.7 | 2.3 | 2.2 | 3.5 | 2.2 |
| | Fe₂O₃ | 0.5 | 0.5 | 0.5 | 0.5 | 1.0 | 0.5 |
| | Sb₂O₃ | 0.6 | 0.6 | — | 0.6 | 0.5 | 0.6 |
| | Nd₂O₃ | — | — | 0.6 | — | 0.5 | — |

| | | | | | | |
|---|---|---|---|---|---|---|
| α(×10⁻⁷/° C.) | 110 | 108 | 109 | 104 | 102 | 105 |
| Softening point (° C.) | 424 | 428 | 426 | 437 | 444 | 431 |
| Thermal stability | ∘ | ∘ | ∘ | ∘ | ∘ | ∘ |
| Surface resistance of | ∘ | ∘ | ∘ | ∘ | ∘ | Δ |
| p+ electrolytic layer | | | | | | |
| Outer appearance | ∘ | ∘ | ∘ | ∘ | ∘ | ∘ |
| Warpage | ∘ | ∘ | ∘ | ∘ | ∘ | ∘ |

TABLE 3

| | | Example | | | | | |
|---|---|---|---|---|---|---|---|
| | | No. 15 | No. 16 | No. 17 | No. 18 | No. 19 | No. 20 |
| Glass | Bi₂O₃ | 71.2 | 73.2 | 74.0 | 72.3 | 69.0 | 76.5 |
| composition | B₂O₃ | 12.3 | 10.0 | 8.0 | 11.2 | 11.0 | 5.4 |
| (mass %) | ZnO | 7.6 | 6.9 | 2.0 | 7.2 | 15.3 | 12.5 |
| | MgO | — | — | — | 0.1 | — | — |
| | CaO | — | — | 0.5 | 0.1 | — | — |
| | SrO | — | — | — | — | — | 0.6 |
| | BaO | 3.0 | 3.3 | 6.5 | 3.5 | 1.5 | 1.5 |
| | CuO | 4.6 | 5.4 | 7.5 | 4.7 | 2.1 | 2.5 |
| | Fe₂O₃ | 0.6 | 0.5 | 0.3 | 0.4 | 0.5 | 0.5 |
| | Sb₂O₃ | 0.7 | 0.2 | 0.7 | 0.5 | 0.5 | 0.5 |
| | Nd₂O₃ | — | 0.5 | — | — | — | — |
| | Al₂O₃ | — | — | 0.5 | — | — | — |

| | | | | | | |
|---|---|---|---|---|---|---|
| α(×10⁻⁷/° C.) | 94 | 101 | 118 | 97 | 91 | 120 |
| Softening point (° C.) | 470 | 464 | 444 | 467 | 485 | 420 |
| Thermal stability | ∘ | ∘ | ∘ | ∘ | ∘ | ∘ |
| Surface resistance of | ∘ | ∘ | ∘ | ∘ | ∘ | ∘ |
| p+ electrolytic layer | | | | | | |
| Outer appearance | ∘ | ∘ | ∘ | ∘ | Δ | Δ |
| Warpage | ∘ | ∘ | ∘ | ∘ | ∘ | ∘ |

TABLE 4

| | | Comparative Example | |
|---|---|---|---|
| | | No. 21 | No. 22 |
| Glass | Bi₂O₃ | 76.8 | — |
| composition | B₂O₃ | 11.5 | 30 |
| (mass %) | SiO₂ | 2.5 | 10 |
| | PbO | 9.1 | 60 |

| | | |
|---|---|---|
| α (×10⁻⁷/° C.) | 91 | 103 |
| Softening point (° C.) | 469 | 388 |
| Thermal stability | ∘ | ∘ |
| Surface resistance of | x | — |
| p+ electrolytic layer | | |
| Outer appearance | x | x |
| Warpage | ∘ | ∘ |

Each sample was produced as follows. First, each glass batch was prepared by blending raw glass materials such as various oxides and carbonates so as to have each of the glass compositions shown in the tables. The glass batch was loaded in a platinum crucible and melted at 1000 to 1100° C. for 1 to 2 hours. Next, part of the molten glass was poured into a mold made of stainless steel to produce a sample for push-rod-type thermomechanical analysis (TMA). The remainder of the molten glass was formed into a film by using a water-cooling roller. The resultant glass film was pulverized in a ball mill, and the resultant pulverized glass was then passed though a sieve having a mesh size of 250 meshes. After that, air classification was carried out to yield glass powders having an average particle diameter D₅₀ of 1.5 μm.

Each resultant glass sample was measured for a thermal expansion coefficient α, a softening point, and thermal stability.

The thermal expansion coefficient α is a value measured with a TMA apparatus and is a value measured in the temperature range of 30 to 300° C.

The softening point is a value measured with a macro-type DTA apparatus. Note that the measurement temperature region in macro-type DTA was set to room temperature to 650° C. and the temperature rise rate was set to 10° C./min.

When a glass sample had a crystallization temperature of 600° C. or more, the thermal stability of the glass sample was defined as “o.” When a glass sample had a crystallization temperature of less than 600° C., the thermal stability of the glass sample was defined as “x.” Note that the crystallization temperature is a value measured with the macro-type DTA apparatus. The measurement temperature region in macro-type DTA was set to room temperature to 650° C. and the temperature rise rate was set to 10° C./min.

Each of the resultant glass powders at 3 mass %, an Al powder (average particle diameter D₅₀ of 0.5 μm) at 75 mass %, and a vehicle (substance obtained by dissolving an acrylic acid ester in α-terpineol) at 23 mass % were kneaded with a three-roll mill, thereby yielding each paste-like electrode formation material. Next, each electrode formation material was applied onto the whole back surface of a silicon semiconductor substrate (100 mm by 100 mm by 200 μm in thickness) by screen printing, followed by drying. After that, the silicon semiconductor substrate was fired at the maximum temperature of 720° C. for a short time (for 2 minutes from the start of the firing to the finish and the maximum temperature was kept for 20 seconds), yielding each back-surface electrode having a thickness of 50 μm. The resultant back-surface electrode was evaluated for the surface resistance of a p+ electrolytic layer, outer appearance, and warpage.

The surface resistance value of the p+ electrolytic layer which was produced by using Sample No. 22 was defined as the standard. The case where the surface resistance value of a p+ electrolytic layer was equal to or less than the standard was defined as “o.” The case where the surface resistance value of a p+ electrolytic layer was higher than the standard was defined as “x” Note that as the surface resistance value of the p+ electrolytic layer is lower, a BFS effect becomes liable to be provided.

The outer appearance was evaluated by examining the numbers of blisters and aggregations of Al through visual observation of the surface of the back-surface electrode. The case where the numbers of blisters and aggregations of Al were 5 or less was defined as “o.” The case where the numbers of blisters and aggregations of Al were 5 to 10 was defined as “Δ.” The case where the numbers of blisters and aggregations of Al were 11 or more was defined as “x.”

The warpage was evaluated by measuring the surface of the light-receiving surface side of the silicon semiconductor substrate with a contact-type surface roughness meter. In the central portion of the silicon semiconductor substrate, the warpage was measured at an interval of 30 mm. The case where the difference in height between the lowermost part and the uppermost part was less than 20 μm was defined as “o.” The case where the difference was 20 μm or more was defined as “x.”

As is evident from Tables 1 to 4, Sample Nos. 1 to 20 each had a lower thermal expansion coefficient and a lower softening point, and were good in the evaluation of the thermal stability. Further, Sample Nos. 1 to 20 each was good in the evaluations of the surface resistance of a p+ electrolytic layer, the outer appearance, and the warpage. On the other hand, Sample No. 21 was not good in the evaluations of the surface resistance of a p+ electrolytic layer and the outer appearance. Sample No. 22 was inferior in the surface resistance of a p+ electrolytic layer and was not good in the evaluation of the outer appearance.

### Example 2

Sample Nos. 1 to 22 each was evaluated for fire through property. The fire through property was evaluated as follows. Each electrode formation material was screen-printed on a SiN film (a thickness of 200 nm) formed on a silicon semiconductor substrate, in the form of lines each having a length of 200 mm and a width of 100 μm. After the electrode formation material was dried, the silicon semiconductor substrate was fired in an electric furnace at 700° C. for 1 minute. Next, the fired silicon semiconductor substrate was immersed in an aqueous solution of hydrochloric acid (concentration of 10 wt %). Then, ultrasonic treatment was carried out for 12 hours to etch each sample. The silicon semiconductor substrate after etching was observed with an optical microscope (magnification of 100 times) to evaluate the fire through property. When a sample penetrated a SiN film and a linear electrode pattern was formed on the silicon semiconductor substrate, the sample was defined as “o.” When a linear electrode pattern was mostly formed on the silicon semiconductor substrate, but there was a portion in which a SiN film was not penetrated, so that the electrical connection of the resultant electrode with the silicon semiconductor substrate was partially disconnected, the sample was defined as “Δ.” When a sample did not penetrate a SiN film, the sample was defined as “x.” As a result, Sample Nos. 1 to 20 each was evaluated as “o” and had good fire through property. Thus, it is thought that Sample Nos. 1 to 20 each is suitable for forming the light-receiving surface electrode of the silicon solar cell. On the other hand, Sample No. 21 was evaluated as “Δ” and had poor fire through property. Further, Sample No. 22 was evaluated as “x” and had poor fire through property.

### INDUSTRIAL APPLICABILITY

The glass composition for electrode formation and electrode formation material of the present invention can be, as described above, suitably used for the electrodes of a silicon solar cell, and in particular, for the formation of a back-surface electrode of a silicon solar cell. Further, the glass composition for electrode formation and electrode formation material of the present invention can be applied to ceramic electronic parts such as a ceramic condenser and optical parts such as a photodiode.

1. A glass composition for electrode formation, comprising, as a glass composition expressed in terms of oxides by mass %, 60 to 90% of Bi₂O₃, 2 to 25% of B₂O₃, 0 to 25% of ZnO, 0.01 to 20% of MgO+CaO+SrO+BaO, and 0 to 25% of SiO₂.

2. A glass composition for electrode formation according to claim 1, wherein the content of ZnO is 7.9% or less.

3. A glass composition for electrode formation according to claim 1, wherein the content of ZnO is smaller than the content of B₂O₃.

4. A glass composition for electrode formation according to claim 1, wherein the content of CaO is 0.1 to 20%.

5. A glass composition for electrode formation according to claim 1, wherein the content of BaO is 0.1 to 20%.

6. A glass composition for electrode formation according to claim 1, wherein the content of SiO₂ is less than 3%.

7. An electrode formation material, comprising a glass powder which includes the glass composition for electrode formation according to claim 1, a metal powder, and a vehicle.

8. An electrode formation material according to claim 7, wherein the glass powder has an average particle diameter D₅₀ of less than 5 μm.

9. An electrode formation material according to claim 7, wherein the glass powder has a softening point of 500° C. or less.

10. An electrode formation material according to claim 7, wherein the glass powder has a crystallization temperature of 600° C. or more.

11. An electrode formation material according to claim 7, wherein a content of the glass powder is 0.2 to 10 mass %.

12. An electrode formation material according to claim 7, wherein the metal powder comprises one kind of powder or two or more kinds of powders of Ag, Al, Au, Cu, Pd, Pt, and alloys thereof.

13. An electrode formation material according to claim 7, wherein the metal powder comprises an Al powder.

14. An electrode formation material according to claim 7, wherein the electrode formation material is used for an electrode of a silicon solar cell.

15. An electrode formation material according to claim 7, wherein the electrode formation material is used for a back-surface electrode of a silicon solar cell.

16. An electrode formation material, comprising a glass powder which includes the glass composition for electrode formation according to claim 2, a metal powder, and a vehicle.

17. An electrode formation material, comprising a glass powder which includes the glass composition for electrode formation according to claim 3, a metal powder, and a vehicle.

18. An electrode formation material, comprising a glass powder which includes the glass composition for electrode formation according to claim 4, a metal powder, and a vehicle.

19. An electrode formation material, comprising a glass powder which includes the glass composition for electrode formation according to claim 5, a metal powder, and a vehicle.

20. An electrode formation material, comprising a glass powder which includes the glass composition for electrode formation according to claim 6, a metal powder, and a vehicle.
